(19) United States
(12) Patent Application Publication
(10) Pub. No.: US 2014/0021017 A1
(43) Pub. Date: Jan. 23, 2014

(54) TRANSMISSION MECHANISM OF VERTICAL CIRCUIT BOARD ETCHING DEVICE

(71) Applicant: MING-HONG KUO, Taipei City (TW)

(72) Inventor: MING-HONG KUO, Taipei City (TW)

(21) Appl. No.: 13/746,310

(22) Filed: Jan. 22, 2013

(30) Foreign Application Priority Data
Jul. 20, 2012 (TW) 101126338

(51) Int. Cl. B65G 13/02

(52) U.S. Cl. CPC B65G 13/02
USPC 198/624

(57) ABSTRACT

Disclosed is a transmission mechanism of vertical circuit board etching device. The transmission mechanism includes a driving shaft unit that has power output terminals respectively coupled to power input terminals of driven shaft units that are of the same number as pairs of clamping/rolling/feeding roller shafts to drive the driven shaft units to rotate. Power output terminals of the driven shaft units are coupled to the pairs of clamping/rolling/feeding roller shafts. Transmission rollers that are contained in the driving shaft unit and the driven shaft units for coupling to each other for changing direction of power transmission and changing speeds of rotation are all rollers that include a plurality of circumferentially-distributed peg-like teeth extending from a roller surface thereof.

### (a) TECHNICAL FIELD OF THE INVENTION

The present invention generally relates to an improved transmission mechanism of vertical circuit board etching device, and more particularly to a novel vertical circuit board etching device of which a whole a set of feeding and etching mechanism, including a transmission mechanism, is more hermetically housed in an enclosure to prevent an etchant liquid that is sprayed inside the enclosure from being contaminated by external dusts to get crystallized and which comprise a peg-like tooth based transmission roller set for transmission of power that has a simple structure so that malfunctioning is not easy to occur and maintenance and repairing are easy.

### (b) DESCRIPTION OF THE PRIOR ART

With the progress of microelectronics and the increasing desire of general consumers for electronic products of compact size, light weight, and powerful functionality, the electronic products that are available in the market are getting increasingly small, sophisticated, and compact. This makes it necessary to form increasingly thinner wiring on a copper-plated surface of a circuit board that carries various electronic components that are contained in various electronic products. Etching operations that are applied to make circuits on the circuit board are thus subjected to severe challenge for quality thereof. It is also challenging to collect, and reuse, the etchant liquid that is applied to the etching operations through a spraying and etching process without contamination by tiny dusts and thus undesired crystallization so as to ensure the purity and quality of the etchant liquid and thus meet the current standards for internal circuit boards of precision electronic products. This is the cause of the emergence of the vertical circuit board etching device to overcome the issue of excessive etching caused by etchant solution being deposited on the top of a circuit board for an excessively long period of time in an etching operation where the circuit board is conveyed horizontally.

A conventional vertical circuit board etching device generally comprises the following components:

two rows of closely arranged vertically-erected rolling/feeding roller shafts that are opposite to each to clamp a circuit board therebetween;

a power transmission gear train that is arranged to supply rotation power to top ends of each row of rolling/feeding roller shafts;

etchant spraying tubes that are vertically erected outside the two rows of rolling/feeding roller shafts and are in communication with etchant liquid supply pipes; and

an enclosure.

Although the conventional vertical circuit board etching device is structured to have most of the components housed in the enclosure, yet the power transmission gear train includes a primary gear set that initially receives the power supplied from an external power device and secondary gears are arranged to operate in two levels of vertical heights for transmission and direction change of power so that the power transmission gear train is generally exposed above a top board of the enclosure to connect to the external power device for receiving the power transmitted therefrom. Thus, the top board of the enclosure must comprise openings formed therein to correspond to the top ends of the rolling/feeding roller shafts for the extension of the top ends of the roller shafts therethrough to fit to corresponding power transmission gears of the power transmission gear train. In addition, all the gears used are bevel gears or spur gears that are operated through engagement between thin and sharp teeth. The following shortcomings are thus caused:

(1) Since the top board of the enclosure must comprise a number of spaced openings at locations corresponding to the top ends of the roller shafts, in a spraying and etching operation, the etchant liquid that is so sprayed to splash around can easily penetrate through the locations where the openings are formed in the top of the enclosure and get lost. Consequently, after several batches of continuous manufacturing process, the amount of the etchant liquid remaining in the enclosure cannot be precisely identified. In addition, the sprayed etchant liquid may be contaminated by dusts that fall into the enclosure through the openings and thus get crystallized. This affects the etching operation and the quality of the etchant liquid.

(2) All the gears of the power transmission gear train, including the primary gear set and the secondary gears, are bevel gears or spur gears that are operated through engagement between thin and sharp teeth. Although these gears are manufactured through precision machining, yet the engaging faces of the thin and sharp teeth may easy get stuck due to dust or crystallized etchant liquid accumulated thereon, making transmission of power fail. Such a problem, if getting very severe, may lead to undesired impact and breaking of the tips of the teeth and consequently malfunctioning may occur very frequently. In addition, the gears that engage each other with thin and sharp teeth may cause an issue of being hard to properly re-align the tips of the teeth to a desired transmission angle during the disassembling and repairing operation. This makes the maintenance very inconvenient.

### SUMMARY OF THE INVENTION

The present invention aims to provide an improved transmission mechanism of vertical circuit board etching device, wherein the vertical circuit board etching device comprises a plurality of pairs of clamping/rolling/feeding roller shafts, a transmission mechanism, a plurality of etchant spraying tubes, and an enclosure. The enclosure is divided into an up portion that forms a feeding and etching chamber and a lower portion that forms a chemical liquid tank. The pairs of clamping/rolling/feeding roller shafts are vertically inserted in the feeding and etching chamber in a single row. The etchant spraying tubes comprise spray nozzles facing the pairs of clamping/rolling/feeding roller shafts and are vertically erected in the feeding and etching chamber respectively at locations adjacent to the pairs of clamping/rolling/feeding roller shafts. The etchant spraying tubes have lower ends extending into the chemical liquid tank. The transmission mechanism is mounted on an inner bottom board of the feeding and etching chamber to correspond to lower ends of the pairs of clamping/rolling/feeding roller shafts, whereby with the transmission mechanism coupled to an external power device, each of the pairs of clamping/rolling/feeding roller shafts is rotated to roll and feed forward a vertically arranged circuit board for etching. Particularly, the transmission mechanism is modified to comprise transmission roller sets including peg-like teeth that are for transmission of power to each clamping/rolling/feeding roller shaft and are mounted to a driving shaft that is arranged parallel beside longitudinally lined-up pairs of clamping/rolling/feeding roller shafts to respectively correspond to the pairs of clamping/rolling/feeding roller shafts and an end of the driving shaft is coupled to an external power device, whereby the whole set of feeding and etching mechanism, including the transmission mechanism, is more hermetically housed in the enclosure and no through hole is necessary in the top of the enclosure so that the sprayed etchant liquid is not contaminated by external dust to get crystallized and the quality of the etching operation an the mass of the etching liquid can be maintained. This is the goal of the present invention.

Further, the present invention provides an improved transmission mechanism of vertical circuit board etching device, which adopts peg-liked tooth based transmission rollers that has a simple structure to transmit power so that the problem of being easily of dirt accumulation and thus making aligning transmission angle of thin and sharp teeth difficult can be avoided, whereby it is hard to malfunction and is easy to maintain and repair. This is another goal of the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an overall perspective view of an improved transmission mechanism of vertical circuit board etching device according to the present invention.

FIG. 2 is an exploded view of the improved transmission mechanism of vertical circuit board etching device according to the present invention.

FIG. 3 is a front view of internal structure of a feeding and etching chamber of the improved transmission mechanism of vertical circuit board etching device according to the present invention.

FIG. 4 is a side elevational view of the internal structure of the feeding and etching chamber of the improved transmission mechanism of vertical circuit board etching device according to the present invention.

FIG. 5 is a partial exploded view of the improved transmission mechanism of vertical circuit board etching device according to the present invention.

FIG. 6 is a schematic view illustrating the use of the improved transmission mechanism of vertical circuit board etching device according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

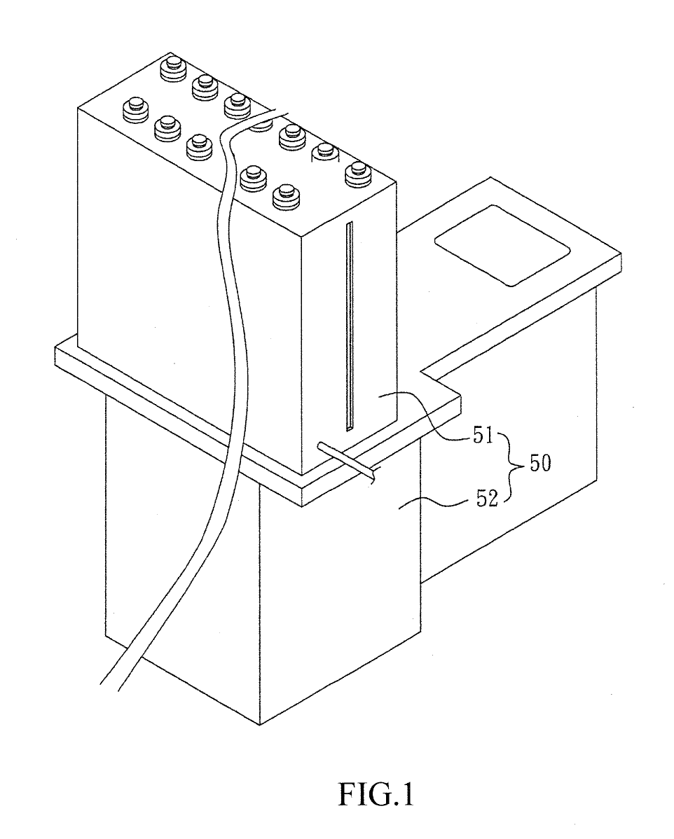

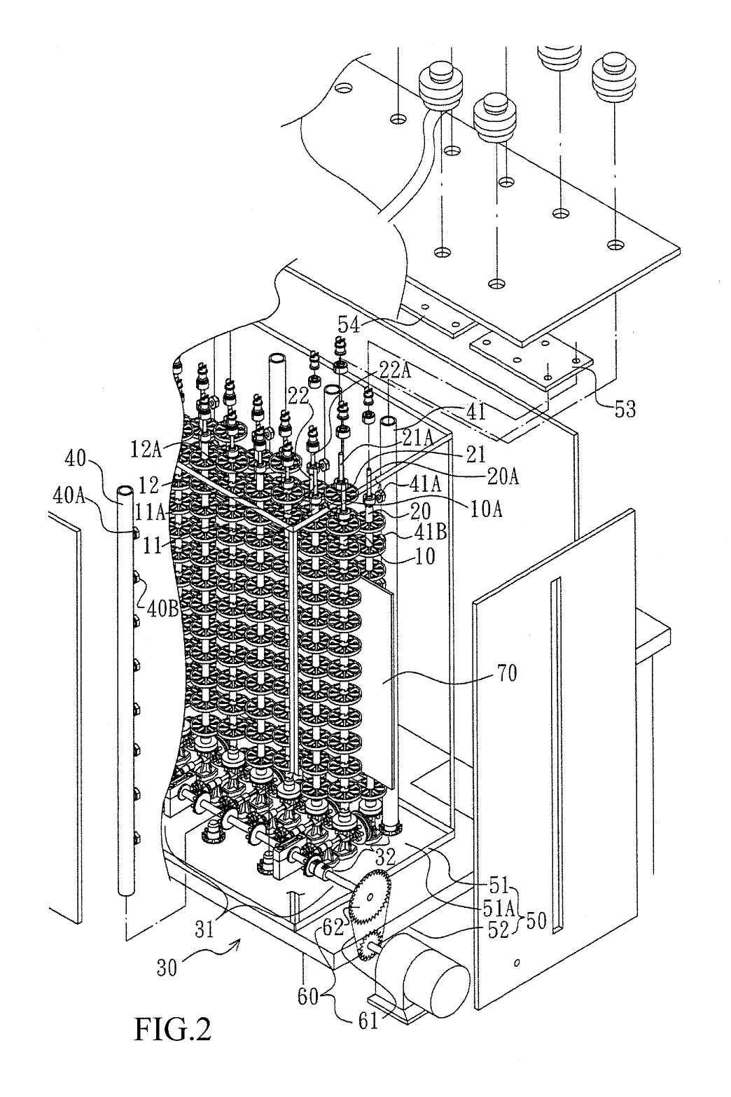

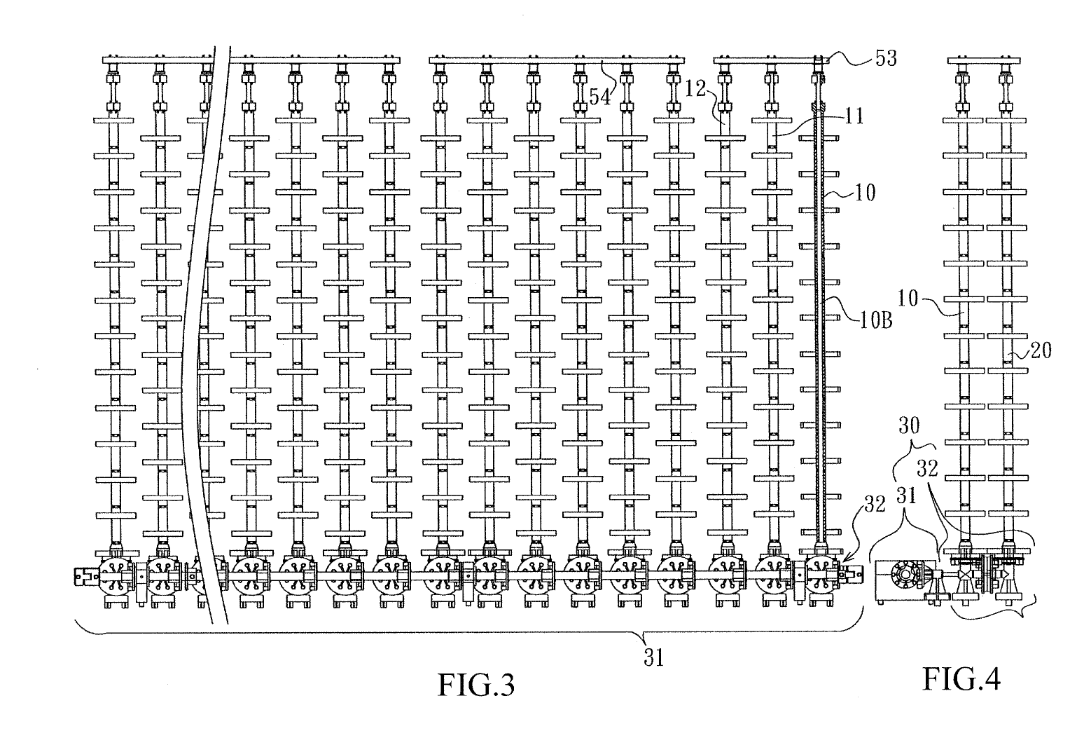

FIG. 1 is an overall perspective view of an improved transmission mechanism of vertical circuit board etching device according to the present invention. Reference is also made to an exploded view shown in FIG. 2, a front view of internal structure of a feeding and etching chamber shown in FIG. 3, and a side elevational view of the internal structure of the feeding and etching chamber shown in FIG. 4. These drawings show that a vertical circuit board etching device in which the improved transmission mechanism of vertical circuit board etching device according to the present invention is embodied comprises a plurality of pairs of clamping/rolling/feeding roller shafts (10 and 20; 11 and 21; 12 and 22), a transmission mechanism 30, a plurality of etchant spraying tubes 40, 41, and an enclosure 50. The enclosure 50 is divided into an up portion that forms a feeding and etching chamber 51 and a lower portion that forms a chemical liquid tank 52. The pairs of clamping/rolling/feeding roller shafts 10, 11, 12, 20, 21, 22 are vertically inserted in the feeding and etching chamber 51 in a single row. The etchant spraying tubes 40, 41 that comprise spray nozzles 40A, 40B, 41A, 41B facing the pairs of clamping/rolling/feeding roller shafts 10, 11, 12, 20, 21, 22 are vertically erected in the feeding and etching chamber 51 respectively at locations adjacent to the pairs of clamping/rolling/feeding roller shafts 10, 11, 12, 20, 21, 22. The etchant spraying tubes 40, 41 have lower ends extending into the chemical liquid tank 52. The transmission mechanism 30 is mounted on an inner bottom board 51A of the feeding and etching chamber 51 to correspond to lower ends of the pairs of clamping/rolling/feeding roller shafts 10, 11, 12, 20, 21, 22, whereby with the transmission mechanism 30 coupled to an external power device 60, each of the pairs of clamping/rolling/feeding roller shafts 10, 11, 12, 20, 21, 22 is rotated to roll and feed forward a vertically arranged circuit board 70 for etching. Particularly, the transmission mechanism 30 comprises a driving shaft unit 31 that has power output terminals respectively coupled to power input terminals of the driven shaft units 32 that are of the same number as the pairs of clamping/rolling/feeding roller shafts 10, 11, 12, 20, 21, 22 to drive the driven shaft units 32 to rotate. Power output terminals of the driven shaft units 32 are coupled to the pairs of clamping/rolling/feeding roller shafts 10, 11, 12, 20, 21, 22. Transmission rollers that are contained in the driving shaft unit 31 and the driven shaft units 32 for coupling to each other for changing direction of power transmission and changing speeds of rotation are all rollers that comprise a plurality of circumferentially-distributed peg-like teeth extending from a roller surface thereof.

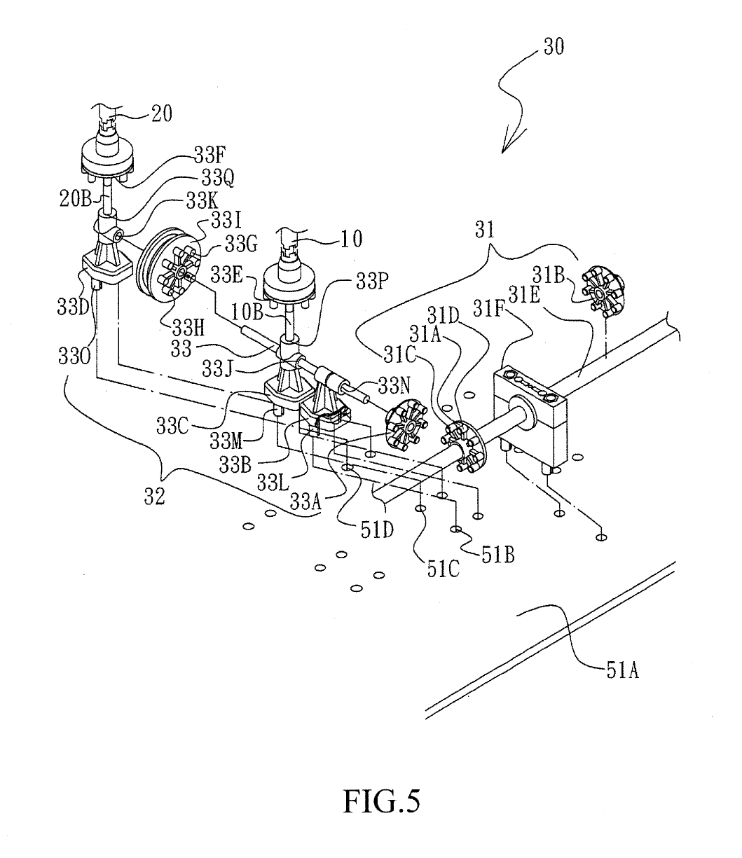

Detailed structure of the transmission mechanism 30 is shown in a partial exploded view of FIG. 5. The driving shaft unit 31 comprises a driving shaft 31E, a plurality of driving shaft seats 31F, and first transmission rollers 31A, 31B that are of the same number as the pairs of clamping/rolling/feeding roller shafts 10, 11, 12, 20, 21, 22 and are mounted to the driving shaft 31E. The driving shaft 31E has an end coupled to the external power device 60 and the first transmission rollers 31A, 31B function as the power output terminals of the driving shaft unit 31. The peg-like teeth 31C, 31D of the first transmission rollers 31A, 31B are set beside the pairs of clamping/rolling/feeding roller shafts 10, 11, 12, 20, 21, 22 to couple to the driven shaft units 32 for output of rotation power. Each of the driven shaft units 32 comprises a driven shaft 33, a second transmission roller 33A, a driven shaft seat 33B, a pair of roller shaft holders 33C, 33D, a pair of fourth transmission rollers 33E, 33F, and a third transmission roller 33I that has opposite roller surfaces from each of which a plurality of peg-like teeth 33G, 33H projects. The pair of roller shaft holders 33C, 33D each have a top end forming a top opening 33P, 33Q. The pair of roller shaft holders 33C, 33D and the driven shaft seat 33B each comprise a transverse shaft bore 33J, 33K, 33N that extends transversely through opposite sides of an intermediate section thereof. A retention pin 33L, 33M, 33O perpendicularly extends from a bottom end of each of the roller shaft holders 33C, 33D and the driven shaft seat 33B, whereby the retention pins 33L, 33M, 33O are inserted into and thus fix the roller shaft holders 33C, 33D to retention holes 51B, 51C, 51D formed in the inner bottom board 51A at corresponding installation locations. The tops of the fourth transmission rollers 33E, 33F are fit to the bottoms of the pair of clamping/rolling/feeding roller shafts 10, 20 in such a way that ends of core spindles 10B, 20B of the pair of clamping/rolling/feeding roller shafts 10, 20 that extend out of bottoms of the fourth transmission rollers 33E, 33F are fit into the top openings 33P, 33Q of the roller shaft holders 33C, 33D. The driven shaft 33 extends horizontally through the transverse shaft bores 33J, 33K of the pair of roller shaft holders 33C, 33D. The portion of the driven shaft 33 that projects toward the first transmission rollers 31A, 31B is first fit through the transverse shaft bore 33N of the driven shaft seat 33B and the end of the driven shaft 33 that projects toward the first transmission rollers 31A, 31B is then fit to the second transmission roller 33A to allow the second transmission roller 33A to function as the power input terminal of the driven shaft unit 32 and the teeth of the second transmission roller 33A are set in engagement with the peg-like teeth 31C, 31D of the first transmission rollers 31A, 31B for power transmission. The portion of the driven shaft 33 that is located between the pair of roller shaft holders 33C, 33D is fit to a central bore of the third transmission roller 33I in such a way that the peg-like teeth 33G, 33H of the third transmission roller 33I are respectively in engagement with teeth of the fourth transmission rollers 33E, 33F so that the fourth transmission rollers 33E, 33F can function as power output terminals of the driven shaft unit 32. Further, as illustrated in the exploded view of FIG. 2, the pairs of clamping/rolling/feeding roller shafts 10, 11, 12, 20, 21, 22 have top-end pins 10A, 11A, 12A, 20A, 21A, 22A for which at least one top board 53, 54 that is arranged in a line for receiving the top-end pins 10A, 11A, 12A, 20A, 21A, 22A to extend therethrough and couple therewith.

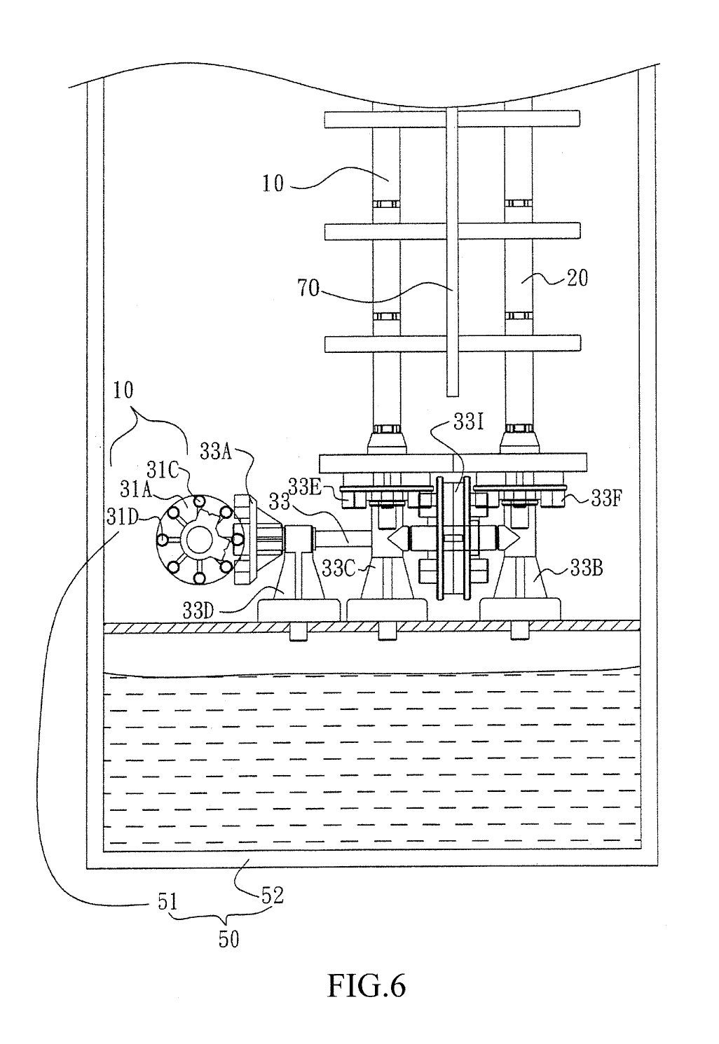

Since each pair of clamping/rolling/feeding roller shafts 10, 11, 12, 20, 21, 22 is operated in the same way, in the illustration of FIG. 6, the description is given to only one pair of clamping/rolling/feeding roller shafts 10, 20 as an example. In a rolling/feeding and etching operation, the external power device 60 (which is not shown in the drawing but is illustrated in a previous drawing) is activated so that the external power device 60 applies a chain 61 thereof to drive a toothed wheel 62 for rotating the driving shaft 31E that in turn causes the first transmission roller 31A mounted thereto to rotate. The first transmission roller 31A in turn drives the second transmission roller 33A to rotate so that the roller 33A rotates the driven shaft 33 to have rotation power transmitted through the shaft 33 to the third transmission roller 33I. The third transmission roller 33I, once rotated, drives the fourth transmission rollers 33E, 33F at opposite sides thereof to rotate so that the pair of clamping/rolling/feeding roller shafts 10, 20 coupled to these rollers 33E, 33F are caused to rotate in opposite direction to induce a rolling action that makes a vertically arranged circuit board 70 to be etched that is fed into a gap between the pair of clamping/rolling/feeding roller shafts 10, 20 clamped between and rolled by the pair of clamping/rolling/feeding roller shafts 10, 20 for feeding forward. Meanwhile, the spray nozzles 40A, 40B, 41A, 41B that are mounted to the etchant spraying tubes 40, 41 that shown in the previously drawings consistently spray an etchant liquid to the circuit board 70, so that when the circuit board 70 is fed out of the vertical circuit board etching device of the present invention, the etching of circuit on the circuit board 70 is completed.

In summary, the present invention provides an improved transmission mechanism of vertical circuit board etching device enables the whole set of feeding and etching mechanism, including the transmission mechanism, to be completely housed in the enclosure so that the sprayed etchant liquid is not contaminated by external dust to get crystallized. Further, transmission rollers including peg-like teeth that are of a simple structure are used to transmit power so as to achieve an effect of being not easy to get malfunctioning and being easy to maintain and repair.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A transmission mechanism of vertical circuit board etching device, wherein the vertical circuit board etching device comprises a plurality of pairs of clamping/rolling/feeding roller shafts, a transmission mechanism, a plurality of etchant spraying tubes, and an enclosure, the enclosure being divided into an up portion that forms a feeding and etching chamber and a lower portion that forms a chemical liquid tank, the pairs of clamping/rolling/feeding roller shafts being vertically inserted in the feeding and etching chamber in a single row, the etchant spraying tubes comprising spray nozzles facing the pairs of clamping/rolling/feeding roller shafts and being vertically erected in the feeding and etching chamber respectively at locations adjacent to the pairs of clamping/rolling/feeding roller shafts, the etchant spraying tubes having lower ends extending into the chemical liquid tank, the transmission mechanism being mounted on an inner bottom board of the feeding and etching chamber to correspond to lower ends of the pairs of clamping/rolling/feeding roller shafts, whereby with the transmission mechanism coupled to an external power device, each of the pairs of clamping/rolling/feeding roller shafts is rotated to roll and feed forward a vertically arranged circuit board for etching, and being different from a transmission mechanism of a conventional vertical circuit board that use toothed wheels of thin and sharp teeth as transmission wheels for changing direction of power transmission and changing speed of rotation and being characterized in that the transmission mechanism comprises a driving shaft unit that has power output terminals respectively coupled to power input terminals of the driven shaft units that are of the same number as the pairs of clamping/rolling/feeding roller shafts to drive the driven shaft units to rotate, power output terminals of the driven shaft units being coupled to the pairs of clamping/rolling/feeding roller shafts, transmission rollers that are contained in the driving shaft unit and the driven shaft units for coupling to each other for changing direction of power transmission and changing speeds of rotation are all rollers that comprise a plurality of circumferentially-distributed peg-like teeth extending from a roller surface thereof.

2. The transmission mechanism of vertical circuit board etching device according to claim 1, wherein the driving shaft unit comprises a driving shaft, a plurality of driving shaft seats, and first transmission rollers that are of the same number as the pairs of clamping/rolling/feeding roller shafts and are mounted to the driving shaft, the driving shaft having an end coupled to the external power device, the first transmission rollers functioning as the power output terminals of the driving shaft unit, the peg-like teeth of the first transmission rollers being set beside the pairs of clamping/rolling/feeding roller shafts to couple to the driven shaft units for output of rotation power.

3. The transmission mechanism of vertical circuit board etching device according to claim 1, wherein each of the driven shaft units comprises a driven shaft, a second transmission roller, a driven shaft seat, a pair of roller shaft holders, a pair of fourth transmission rollers, and a third transmission roller that has opposite roller surfaces from each of which a plurality of peg-like teeth projects, the pair of roller shaft holders each having a top end forming a top opening, the pair of roller shaft holders and the driven shaft seat each comprising a transverse shaft bore that extends transversely through opposite sides of an intermediate section thereof, a retention pin perpendicularly extending from a bottom end of each of the roller shaft holders and the driven shaft seat, whereby the retention pins are inserted into and thus fix the roller shaft holders to retention holes formed in the inner bottom board at corresponding installation locations, the tops of the fourth transmission rollers being fit to the bottoms of the pair of clamping/rolling/feeding roller shafts in such a way that ends of core spindles of the pair of clamping/rolling/feeding roller shafts that extend out of bottoms of the fourth transmission rollers are fit into the top openings of the roller shaft holders, the driven shaft extending horizontally through the transverse shaft bores of the pair of roller shaft holders, the portion of the driven shaft that projects toward the first transmission rollers being first fit through the transverse shaft bore of the driven shaft seat, the end of the driven shaft that projects toward the first transmission rollers being then fit to the second transmission roller to allow the second transmission roller to function as the power input terminal of the driven shaft unit and the teeth of the second transmission roller are set in engagement with the peg-like teeth of the first transmission rollers for power transmission, the portion of the driven shaft that is located between the pair of roller shaft holders being fit to a central bore of the third transmission roller in such a way that the peg-like teeth of the third transmission roller are respectively in engagement with teeth of the fourth transmission rollers so that the fourth transmission rollers function as power output terminals of the driven shaft unit.
